(19) United States
(12) Patent Application Publication
(10) Pub. No.: US 2005/0246553 A1
(43) Pub. Date: Nov. 3, 2005

(54) Mobile terminal and data protection system

(76) Inventors: Hideki Nakamura, Yokohama (JP); Toru Nagura, Chigasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/894,046

(22) Filed: Jul. 20, 2004

(30) Foreign Application Priority Data
Apr. 30, 2004 (JP) 2004-136111

(51) Int. Cl. H04L 9/32; G06F 11/30; G06F 12/14

(52) U.S. Cl. 713/193

(57) ABSTRACT

A mobile terminal which is usable by a plurality of users enables only a regular user to browse data for the regular user of the mobile terminal.

An IC card 3 installed in a mobile terminal stores an encryption key 4 and a decryption key 5. Input data 10 is subjected to data encryption processing by using the encryption key 4 read from the IC card 3 to be transformed to encrypted data 14 and is then stored in a storage device 7. In addition, the encrypted data 14 read from the storage device 7 is subjected to decryption processing 6 in data decryption processing 200 by using the decryption key 5 to be decrypted to the original data. For different IC cards, different encryption keys 4 and different decryption keys 5 are assigned, and therefore, the data 14 will be subjected to the decryption processing 6 with a different decryption key 5. Consequently, the data 14 thus encrypted will not be decrypted correctly.

### CLAIM OF PRIORITY

The present application claims priority from Japanese application serial no. JP2004-136111, filed on Apr. 30, 2004, the content of which is hereby incorporated by reference into this application.

### BACKGROUND OF THE INVENTION

The present invention relates to a mobile terminal such as a mobile phone using an IC card, and a data protection system.

Today, various measures are available for a mechanism to protect copyrighted data that exists in a mobile terminal.

The predominant protection method is to arrange a mobile terminal to control such copyrighted data so that it cannot be fetched beyond the mobile terminal. With the method, when a user replaced a mobile terminal, the user has no other choices but to download data again to transfer copyrighted data to the new mobile terminal.

In this connection, as a mechanism to protect copyrighted music data, a data protection method which uses an external memory featuring enhanced security function, or a Universal Distribution with Access Control-Media Base (UDAC-MB) has been developed.

The UDAC-MB stores a license key (encryption key) that is encrypted with a public key generated by an external memory featuring enhanced security functions and data that is encrypted with the license key in the external memory. For reproduction of the data, the encrypted license key is decrypted with a secret key stored in the external memory, thereby decrypting the encrypted data with the encrypted license key. The UDAC-MB thus realizes protection of copyrighted music data (Refer to Patent Document 1 “Japanese Patent Laid-open No. 2002-229861”).

Today, mobile phones which incorporate a User Identity Module (UIM) card, a kind of IC cards that stores user information, are being used more popularly. Such a mobile phone enables different users to use the mobile phone just by replacing a UIM card, which would allow a situation where a number of people use one mobile phone. With such a mobile phone incorporating a UIM card, a user is identified to be the regular user of the UIM card or not by requesting the user to enter his or her password when accessing the UIM card. Security is thus enhanced by limiting the use if the user is found to be not a regular user. Under present situation, however, mobile phones are designed in such a manner that data stored in a mobile phone itself incorporating a UIM card, or data stored in an external memory that is inserted to a mobile phone, can be browsed irrespective of the fact that the UIM card is inserted or not.

Meanwhile, in the technology stated in the above-stated Patent Document 1, a data protection system is employed in which encrypted data as well as an encryption key to cancel encryption of the data and a secret key to cancel encryption of the encryption key are stored in an external memory, and the use of such data is protected by prohibiting acquisition of the secret key from the external memory, even if the encrypted data is fraudulently copied. For the mobile phone incorporating a UIM card stated above in this system, however, when a user who is not a regular user of the mobile phone inserts his or her UIM card, the user is identified to be a regular user for the UIM card thus inserted. Thus, data of the external memory can be read and decoded for possible browsing.

An object of the present invention is to provide a highly reliable mobile phone and a data protection system.

### SUMMARY OF THE INVENTION

For the purpose of achieving the above-described object, a mobile terminal according to the present invention include: an IC card interface adapted to detachably mount an IC card incorporating an encryption key to encrypt data, a decryption key to decrypt the data encrypted by the encryption key and a decryption processing unit; a data encryption processing unit which captures the encryption key from the IC card mounted and encrypts input data with the encryption key; a storage device which stores the data encrypted in the data encryption processing unit; and a data decryption processing unit to decrypt the encrypted-data read from the storage device in the decryption processing unit of the IC card by using the decryption key. A set of encryption key and decryption key, which is assigned to each IC card, is respectively different.

Further, the data encryption processing unit generates random numbers to create a key of symmetric encryption algorithm and also generates encryption data which includes encryption key data and actual encryption data. The input data is encrypted for actual encryption data by using the key of symmetric encryption algorithm and the key of symmetric encryption algorithm is encrypted with an encryption key for encryption key data. Finally, the encryption data is stored in the storage device.

A mobile terminal according to the present invention includes: an IC card interface adapted to detachably mount an IC card incorporating an encryption key to encrypt data, a decryption key to decrypt the data encrypted with the encryption key to the original data, an encryption processing unit and a decryption processing unit; a data encryption processing unit which encrypts the input data in the encryption processing unit by using the encryption key of the IC card; a storage device which stores the encrypted data delivered from the data encryption processing unit; and a data decryption processing unit which decrypts the encrypted data read from the storage device in the decryption processing unit of the IC card by using the decryption key. A set of encryption key and decryption key, which is assigned to each IC card, is respectively different.

The encryption processing unit of the IC card generates random numbers to create a key of symmetric encryption algorithm, and also generates encryption data which includes such encryption key data and actual encryption data. The input data is encrypted for actual encryption data by using the key of symmetric encryption algorithm and the key of symmetric encryption algorithm is encrypted with an encryption key for encryption key data. Finally, the encryption data is stored in a storage device.

The decryption processing unit of the IC card decrypts the encryption key data of the encryption data read from the storage device by using a decryption key to recover the key of symmetric encryption algorithm, and also decrypts actual encryption data of the encryption data by using the recovered key of symmetric encryption algorithm, thus recovering the data to the original data.

The encryption key is contained and stored in a digital certificate, extracted from the digital certificate and is used for encryption processing.

The mobile terminal only encrypts data for which security must be ensured.

The mobile terminal encrypts data partially.

The mobile terminal is provided with a data protection unit which decides whether decrypted data has been correctly decrypted or not, displays or reads decrypted data only when decryption is carried out correctly, and, if the decryption is not correct, a message to the effect that the decryption is incorrect is notified.

To achieve the above-described object, the data protection system according to the present invention uses an IC card including a encryption key to encrypt data and a decryption key to decrypt the data encrypted with encryption key to the original data. Input data is encrypted by using the encryption key captured from the IC card and stored in a storage device. The stored encrypted data is decrypted in the IC card by using the decryption key. A set of encryption key and decryption key, which is assigned to each IC card, is respectively different.

The data protection system according to the present invention uses an IC card which includes an encryption key to encrypt data and a decryption key to decrypt the data encrypted with the encryption key to the original data. Input data is encrypted by using the encryption key in the IC card and stored in a storage device. The stored encrypted data is decrypted in the IC card by using the decryption key. A set of encryption key and decryption key, which is assigned to each IC card, is respectively different.

The data to be encrypted and stored includes encryption data comprising actual encryption data which is created by encrypting data with a key of symmetric encryption algorithm generated from random numbers and encryption key data which is created by encrypting a key of symmetric encryption algorithm with an encryption key.

The decryption processing of the encryption data decrypts the encryption key data of the encryption data and recovers the key of symmetric encryption algorithm, and decrypts the actual encryption data of the encryption data with the recovered key of symmetric encryption algorithm, thus recovering the encryption data to the original data.

The encryption key is contained and stored in a digital certificate, and is extracted from the digital certificate for use with encryption processing.

Furthermore, a decision is made as to whether decrypted data has been correctly decrypted. The decrypted data is displayed or read only when decryption is carried out correctly. If the decryption is not correct, a message to the effect that the decryption is incorrect is notified.

According to the present invention, it is possible to provide a highly reliable mobile terminal and data protection system.

### BRIEF DESCRIPTION OF THE DRAWINGS

FIG. 1 is a functional block diagram showing an embodiment of a mobile terminal and a data protection system according to the present invention;

FIG. 2 is a diagram describing the outline of processing wherein an IC card which is different from that used for data encryption processing of the embodiment shown in FIG. 1;

FIG. 3 is a block diagram showing a specific example of a hardware configuration of the IC card used in FIG. 1;

FIG. 4 is a block diagram showing a specific example of a hardware configuration of the mobile terminal shown in FIG. 1;

FIG. 5 is a flow chart showing a specific example of a data encryption processing unit 100 shown in FIG. 1;

FIG. 6 is a pattern diagram showing a specific example of a digital certificate to be stored in the IC card shown in FIG. 1;

FIG. 7 is a flow chart showing a specific example of encryption key acquisition processing shown in FIG. 5;

FIG. 8 is a flow chart showing a specific example of data decryption processing 200 shown in FIG. 1;

FIG. 9 is a flow chart showing another specific example of data encryption processing 100 shown in FIG. 1;

FIG. 10 is a pattern diagram showing a specific example of encryption data to be generated by the data encryption processing 100 shown in FIG. 9; and

FIG. 11 is a flow chart showing another specific example of the data decryption processing 200 shown in FIG. 1.

### DESCRIPTION OF THE PREFERRED EMBODIMENTS

Hereinafter, preferred embodiments of the present invention will be described with reference to the accompanying drawings.

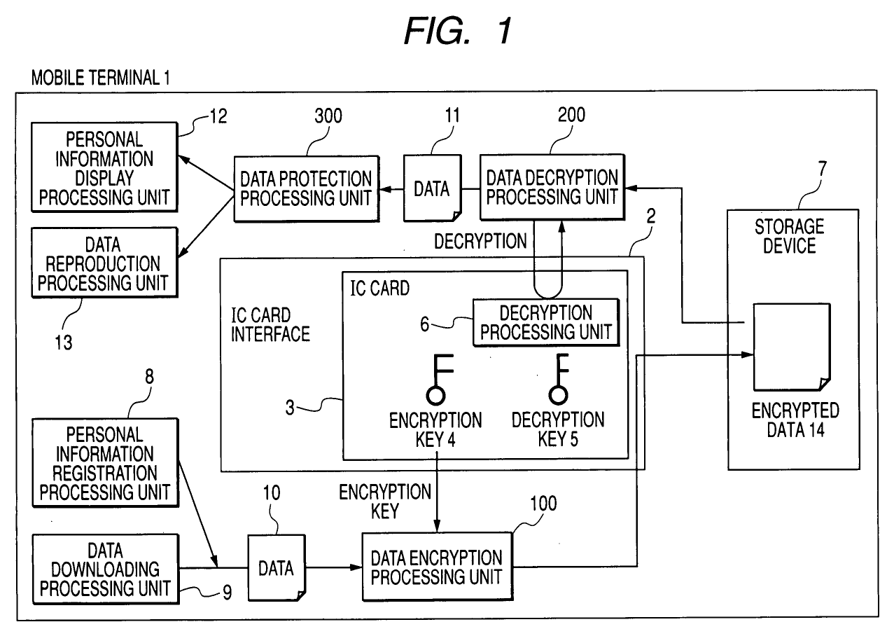

FIG. 1 is a functional block diagram showing an embodiment of a mobile terminal and a data protection system according to the present invention, wherein reference numeral 1 denotes a mobile terminal; 2 an IC card interface; 3 an IC card; 4 an encryption key; 5 a decryption key; 6 a decryption processing unit; 7 a storage device; 8 personal information registration processing unit; 9 data downloading processing unit; 10 data; 11 data; 12 personal information display processing unit; 13 data reproduction processing unit; 14 encrypted data; 100 a data encryption processing unit; 200 a data decryption processing unit; and 300 a data protection processing unit.

Referring to FIG. 1, the mobile terminal 1 incorporates the IC card interface 2 which enables the IC card 3 to be attached thereto and removed therefrom and thus allows the IC card 3 to be plugged or unplugged freely. In addition, its typical example is a mobile phone which can mount a UIM card thereto.

The IC card 3 stores the encryption key 4 to encrypt data and the decryption key 5 which associates with the encryption key 4, wherein the encryption key 4 is externally read to be used for encryption of the data 10, and decryption of data encrypted with the decryption key 5 is carried out in the decryption processing unit 6. It should be noted that the decryption processing unit 6 is arranged within the IC card 3.

In this case, a configuration in which the encryption key 4 can direct be acquired from the IC card 3 may be possible. Alternatively, however, it is also possible to have a configuration to acquire a digital certificate which includes an encryption key and extract the encryption key from the acquired digital certificate for use with data encryption processing. An example of an IC card which stores the encryption key 4 as being included in a digital certificate is a User Identity Module (UIM) card which is compatible with a Wireless Identity Module (WIM). It should be noted that the WIM implies software on an IC card which stores security information stipulated by the Open Mobile Alliance (OMA), and it stores a digital certificate which stores an encryption key, a decryption key that matches the encryption key, a program to decrypt the data by using the decryption key, etc. The use of the WIM enables to correctly decrypt the data encrypted with the encryption key 4 thorough the decryption processing unit 6 of the IC card 3.

The mobile terminal 1 also includes the storage device 7. The storage device 7 is capable of storing personal data registered by a user, content data downloaded through a network, etc., typical examples of which include a flash ROM, an SD card, and a mini SD card.

With the mobile terminal 1, the IC card 3 must be inserted in the IC card interface 2 whenever personal data of a user or a downloaded content is to be stored in the storage device 7. The data 10, such as registration-processed personal data from the personal information registration processing unit 8 or content data from the data downloading processing unit 9, is encrypted in the data encryption processing unit 100 by using the encryption key 4 acquired from the IC card 3 that is inserted to the IC card interface 2, and the data 10 is then stored in the storage device 7 as the encrypted data 14.

As described in the above, for a case where data stored in the storage device 7 is extracted for displaying personal data or reproducing content data, the data decryption processing unit 200 uses the decryption key 5 and the decryption processing 6 in the IC card 3 to perform decryption processing on the encrypted data 14 that is read from the storage device 7, thereby obtaining the decrypted data 11. The data 11 is decided by the data protection processing unit 300 as to whether it is correctly decrypted or not. When the data is decided to have been correctly decrypted, the data is displayed on the personal information display processing unit 12 if the decrypted data 11 is personal information, or otherwise, reproduction processing is executed in the data reproduction processing unit 13 if the data is content data.

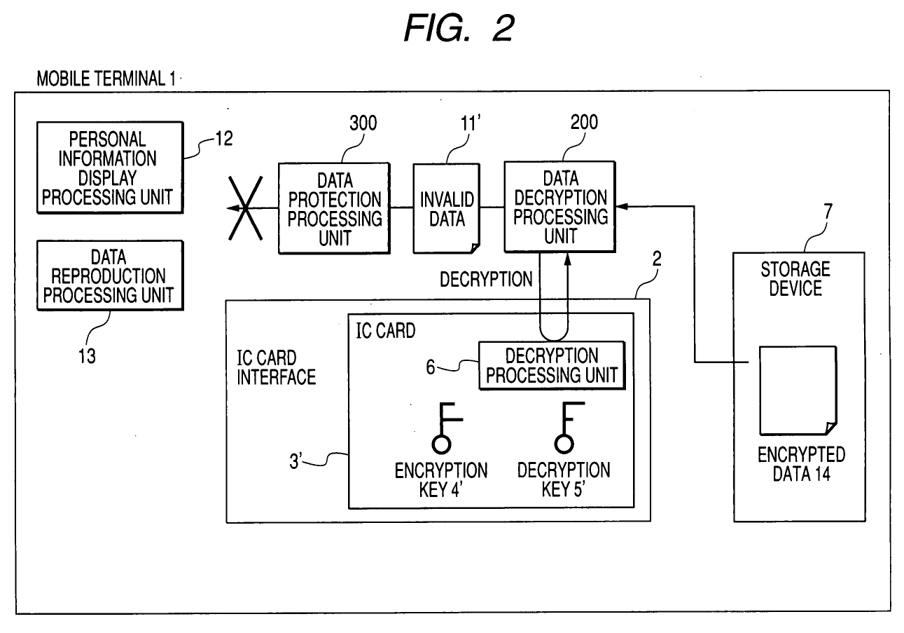

Here, as shown in FIG. 2, when an IC card 3′ which is different from the IC card 3 shown in FIG. 1 is inserted to the mobile terminal 1 so as to read the encrypted data 14 stored in the storage device 7 by using the above-stated IC card 3, the encrypted data 14 is decrypted in the manner as described earlier in the data decryption processing unit 200. For the processing, however, a decryption key 5′ stored in the IC card 3′ and the decryption processing 6 are used. Here, the decryption processing 6 is common to the IC cards 3 and 3′, but an encryption key or a decryption key is assigned to each IC card. Consequently, the encryption key 4′ and the decryption key 5′ are different from the encryption key 4 and the decryption key 5 of the IC card 3, respectively.

In this connection, when the IC card 3′ is used to execute, in the decryption processing unit 200, the decryption processing on the encrypted data 14 in the IC card 3 (FIG. 1) captured from the storage device 7, data 11′ obtained as a result of such processing cannot be correct decrypted data. Consequently, the data protection processing unit 300 decides the data 11′ to be invalid, and processing in the personal information display processing unit 12 or processing of content data in the data reproduction processing unit 13 is not initiated.

As described above, security of personal information that is input by a user or content data downloaded by a user can be compensated.

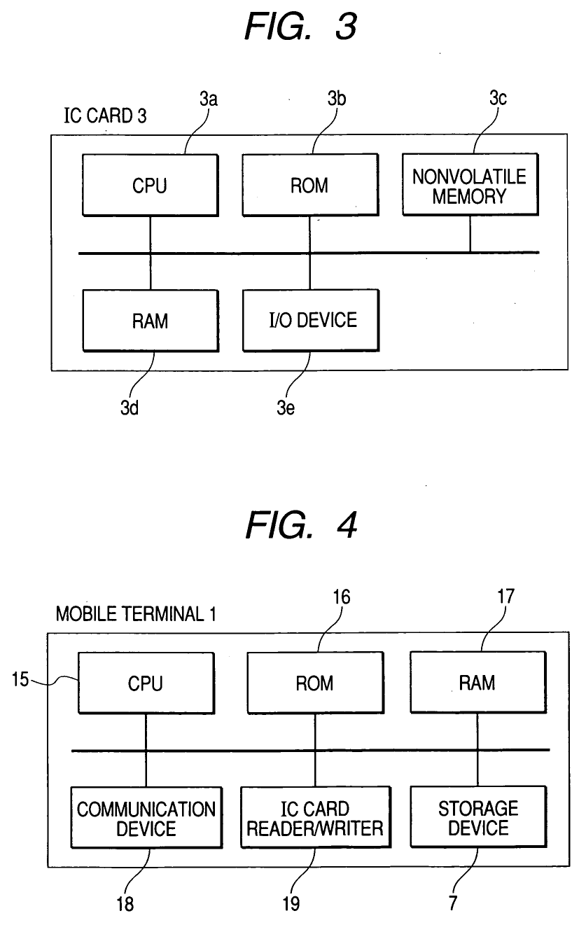

FIG. 3 is a block diagram showing a hardware configuration of the IC card 3 of in FIG. 1 by way of specific example. Reference numeral 3a denotes a Central Processing Unit (CPU); 3b a Read Only Memory (ROM); 3c a nonvolatile memory; 3d a Random Access Memory (RAM); and 3e an I/O device.

Referring to FIG. 3, the CPU 3a executes various programs for controlling communications with an external device (the mobile terminal 1 shown in FIG. 1, in this case) via the I/O device 3e, executing the decryption processing 6 (FIG. 1) with the decryption key 5 (FIG. 1), for example. Such programs are stored in the ROM 3b. When the CPU 3a executes a program stored in the ROM 3b for certain processing, data required for such processing is temporarily stored in the RAM 3d.

The nonvolatile memory 3c stores the encryption key 4 (FIG. 1) or data such as a digital certificate containing the encryption key 4 and the encryption key 5.

The I/O device 3e constitutes an interface which executes communications with a device to which the IC card 3 is inserted, or more specifically with the mobile terminal 1. Through communications with the mobile terminal 1, the I/O device 3e acquires a command from the mobile terminal 1 or transfers a response to the command to the mobile terminal 1.

FIG. 4 is a block diagram showing a hardware configuration of the mobile terminal 1 shown in FIG. 1 by way of example, wherein reference numeral 6 denotes the storage device shown in FIG. 1; 15 a CPU; 16 a ROM; 17 a RAM; 18 a communication device; and 19 an IC card reader/writer.

Referring to FIG. 4, the mobile terminal 1 includes the storage device 6, the CPU 15, the ROM 16, the RAM 17, the communication device 18, and the IC card reader/writer. The CPU 15, by executing various programs stored in the ROM 16, executes various processing on the personal information registration processing unit 8, the data downloading processing unit 9, the data reproduction processing unit 100, the data decryption processing unit 200, the data protection processing unit 300, the personal information display processing unit 12, the data reproduction processing unit 13, etc., controls writing/reading of data to or from the storage device 7, and also controls the communication device 18. The RAM 17 is used as a working area when the CPU 15 executes such processing or controls.

The IC card reader/writer 19 is a component that configures the IC card interface 2 in FIG. 1 and allows the IC card 3 to be plugged or unplugged. The mobile terminal 1 transmits a command to the installed IC card 3 or receives a response from the IC card 3 via the IC card reader/writer 19.

The communication device 18 is connected to a network and is used to download data of various contents such as music data and video data available on the network to the mobile terminal 1.

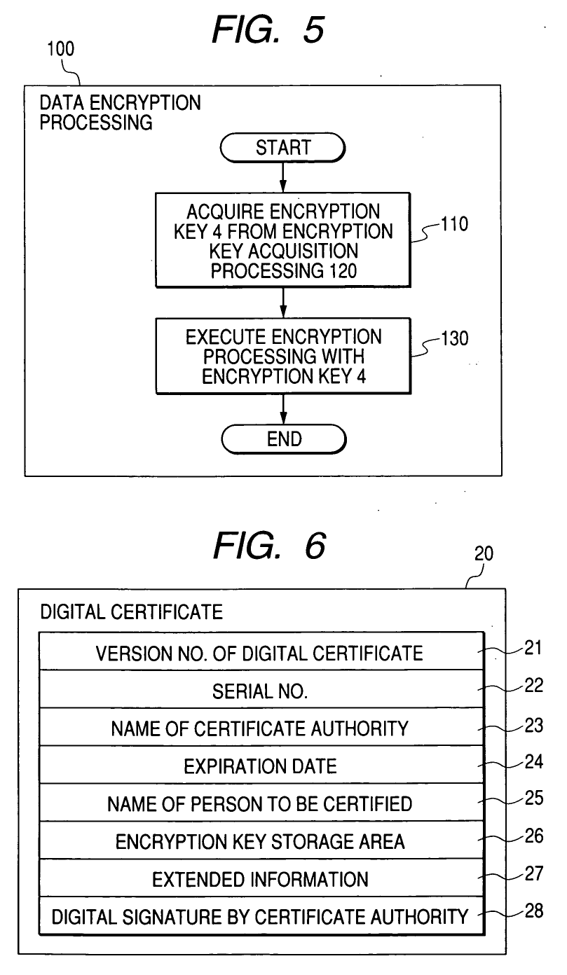

FIG. 5 is a flow chart showing the data encryption processing unit 100 shown in FIG. 1 by way of specific example.

Referring to FIG. 5, the mobile terminal 1 allows the IC card reader/writer 19 (FIG. 4) to transmit a command requesting the encryption key 4 of the IC card 3 and receives the encryption key 4 from the IC card 3 in the IC card reader/writer 19 (Step 110). Thereafter, the mobile terminal 1 encrypts the data 10 (FIG. 1) with the encryption key 4 (Step 130).

Here, in FIG. 3, the encryption key 4 and the decryption key 5 are stored in the nonvolatile memory 3c of the IC card 3. When the above-stated request command from the mobile terminal 1 is captured through the I/O device 3e, the CPU 3a reads the encryption key 4 from the nonvolatile memory 3c in response to the request command, and the encryption key 4 is transmitted to the mobile terminal 1 from the I/O device 3e as a response. Thus, the data encryption processing unit 100 can acquire the encryption key 4 from the IC card 3.

In this arrangement, the data encryption processing unit 100 may be configured to directly acquire the encryption key 4 from the IC card 3. Alternatively, however, it may also be configured that direct acquisition of the encryption key 4 from the IC card 3 is prohibited by using another IC card 3 in which the encryption key 4 is stored as part of a digital certificate, as is the case with a UIM card that is compatible with the WIM. In this connection, the data encryption processing unit 100 is configured to be able to execute encryption key acquisition processing 120. The encryption key acquisition processing 120 is configured to acquire a digital certificate from the IC card 3. In this case, in FIG. 5, by executing the encryption key acquisition processing 120, a digital certificate is acquired from the IC card 3 (Step 110) and the encryption key 4 is extracted from the digital certificate thus acquired to encrypt the data (Step 130).

FIG. 6 is a pattern diagram showing a specific example of such digital certificate.

Referring to FIG. 6, a digital certificate 20 includes: a version number of digital certificate 21; a serial number 22 of the digital certificate 20; a name of certificate authority 23; an expiration date 24 of the digital certificate 20; a name of person to be certified (i.e., the regular holder of an encryption key to be certified (authorized) by the digital certificate) 25; an encryption key storage area 26 which stores the certified encryption key 4; extended information 27; and a digital signature by certificate authority 28.

The digital certificate 20 having such configuration is stored in the nonvolatile memory 3c (FIG. 3) of the IC card 3. The digital certificate 20 is read from the nonvolatile memory 3c responding to a request command from the mobile terminal 1 for the encryption key and is transmitted to the IC card reader/writer 19 (FIG. 4) of the mobile terminal 1 from the I/O device 3b (FIG. 3). In the mobile terminal 1, the CPU 15 (FIG. 4) locates the encryption key storage area 26 of the digital certificate 20 thus received and reads the encryption key storage area 26, thus enabling to acquire the encryption key 4.

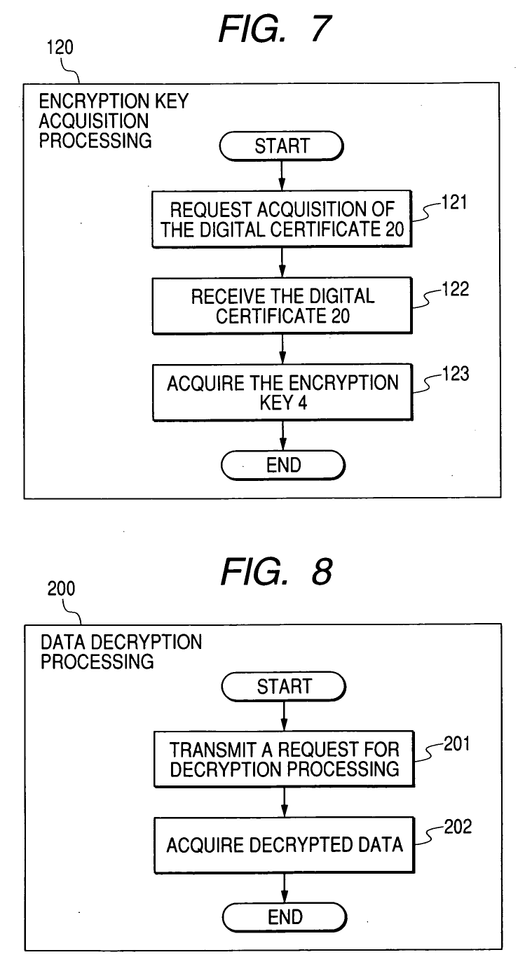

FIG. 7 is a flow chart showing a specific example of such encryption key acquisition processing 120.

Referring to FIG. 7, first, a command requesting the digital certificate 20 is transmitted to the IC card 3 (Step 121). When response data is received from the IC card 3, the digital certificate 20 is acquired from the response data (Step 122). Thereafter, the encryption key storage area 26 of the acquired digital certificate 20 is read to acquire the encryption key 4 (Step 123).

Through the procedures stated in the above, it is possible to acquire the encryption key 4 from the IC card 3. However, when the IC card 3 is not inserted to the mobile terminal 1, acquisition of the encryption key from the IC card 3 is not possible, so that the data 10 (FIG. 1) such as personal information entered by a user and downloaded content data cannot be processed in the data encryption processing unit 100. Consequently, such data cannot be stored in the storage device 7.

FIG. 8 is a flow chart showing a specific example of the data decryption processing 200 shown in FIG. 1.

Referring to FIG. 8, the mobile terminal 1, when reading the desired encrypted data 14 from the storage device 7, first transmits a command requesting data decryption, and encrypted data 14 read from the storage device 7 to the IC card 3 (Step 201). In the IC card 3, the encrypted data 14 is decrypted in the decryption processing unit 6 with the decryption key 5 incorporated in the IC card 3 and is returned to the mobile terminal 1 as response data. The mobile terminal 1, upon receiving the response data from the IC card 3, acquires decrypted data from the response data received (Step 202).

Thus, the desired encrypted data 14 stored in the storage device 7 is decrypted with the decryption key 5 in the IC card 3, and the decrypted data 11 is then processed in the data protection processing unit 300.

It should be noted that, however, when the IC card 3 is not inserted to the mobile terminal 1, the encrypted data stored in the storage device 7 cannot be read since no response is available from the IC card 3 to a command requesting data decryption.

Next, a specific example of processing of the data protection processing unit 300 shown in FIG. 1 will be described.

The data protection processing unit 300 decides whether a header of the decrypted data 11 is invalid. In addition, when a Cyclic Redundancy Check (CRC) is affixed at the end of the data 11, it decides whether there is an inconsistency between the CRC and the data 11. If the data is acknowledged to be invalid, the data protection processing unit 300 executes processing in the personal information display processing unit 12 or initiates processing in the data reproduction processing unit 13 as usual. When the data is acknowledged to be invalid data 11′ (FIG. 2), the data protection processing unit 300 displays a message to the effect that processing concerned cannot be executed in the processing units 12 or 13, thus informing the status to the user.

As stated in the above, processing in the data protection processing unit 300 is executed.

The data encryption processing unit 100 may execute another encryption processing in such a manner that data itself is encrypted with a symmetric encryption algorithm, a key used for the encryption is encrypted by using the encryption key 4 stored in the IC card, and a combination of the two encrypted data is used as encryption data. It should be noted that the symmetric encryption algorithm is a type of encryption algorithms wherein a key used for encryption and a key used for decryption of the encrypted data are the same. Typical examples of the algorithm include the Data Encryption Standard (DES) and the Advanced Encryption Standard (AES).

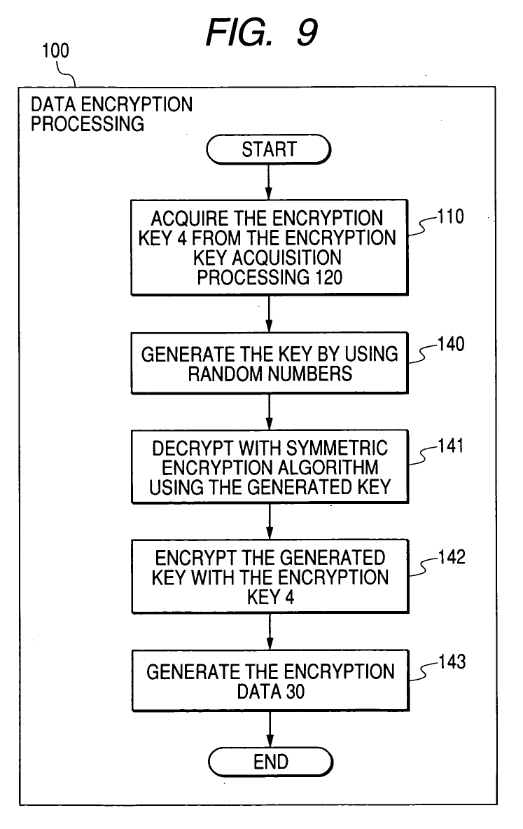

FIG. 9 is a flow chart showing a specific processing example of the data encryption processing 100 shown in FIG. 1 in which such symmetric encryption algorithm is used. Hereinafter, the specific example will be described with reference to FIG. 1.

First, in a similar way as the specific example shown in FIG. 5, the encryption key 4 is acquired from the IC card 3 (Step 110).

Further, random numbers are generated, a key of symmetric encryption algorithm is created based on the random numbers (Step 140), and the data 10 is encrypted with the key of symmetric encryption algorithm (Step 141). Thereafter, the key of symmetric encryption algorithm is encrypted with the above-stated encryption key 4 acquired from the IC card 3 (Step 142). The encryption data 30 is then generated based on the encrypted key of symmetric encryption algorithm (hereinafter referred to as “encryption key data”) and the data encrypted with the key of symmetric encryption algorithm (hereinafter referred to as “actual encryption data”) (Step 143).

The encryption data 30 consists of a header section 31 and a data section 32. The header section 31 contains: an identifier 31a which indicates that the data is encrypted; a data length of header section 31 which indicates the size of the header section 31; a data length of data section 31c which indicates the size of the data section 32; and encryption key data 31d of the key of symmetric encryption algorithm used for encrypting the data section 32. In addition, the data section 32 stores actual encryption data 32a which is encrypted with the key of the symmetric encryption algorithm.

The encryption data 30 having the above-described configuration is stored in the storage device 7 as encrypted data 14.

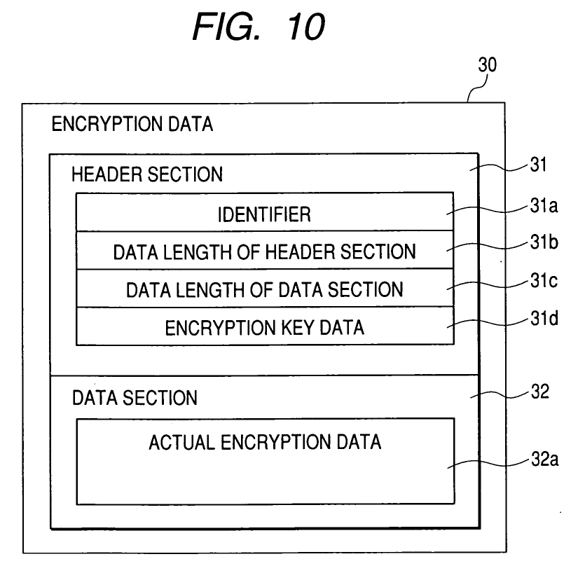

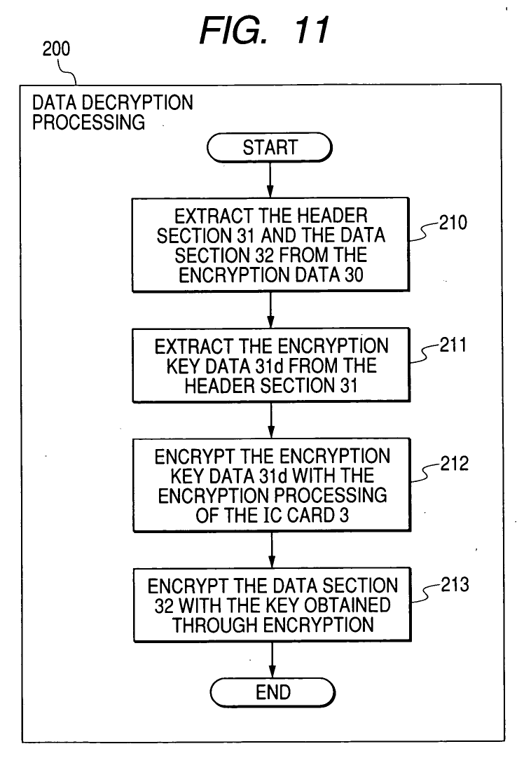

FIG. 11 is a flow chart showing a specific processing example of the data decryption processing 200 which decrypts the encryption data 30 shown in FIG. 10. Hereinafter, the specific example will be described with reference to FIGS. 1 and 10.

First, the encryption data 30 is read from the storage device 7 to extract the header section 31 and the data section 32 therefrom (Step 210), and the encryption key data 31d, which is an encrypted key of symmetric encryption algorithm, is extracted from the header section 31 thus extracted (Step 211). Thereafter, a command requesting decryption processing is transmitted to the IC card 3, with the encryption key data 31d as being a parameter. In the IC card 3, the decryption processing 6 of the encryption key data 31d is performed by using the decryption key 5 to decrypt the key of symmetric encryption algorithm. The IC card 3 returns the encrypted key of symmetric encryption algorithm to the mobile terminal 1 as a response (Step 212). By using the key of symmetric encryption algorithm, the actual encryption data 32a that is already extracted from the data section 32 of the encryption data 30 to recover the original data 11 (Step 213).

With such an arrangement, it is possible to decrypt the actual encryption data that is encrypted with the key of symmetric encryption algorithm to the original data.

As described in the above embodiment, data is encrypted and stored with an encryption key stored in an IC card. To read the encrypted data for display or reproduction, the encrypted data can be correctly recovered to the original data only when a decryption key that is stored in the same IC card which stores the encryption key used for encrypting the encrypted data. Consequently, when another IC card that is different from the above-stated IC card is used, the above-stated encrypted data cannot be recovered correctly since the encryption key and the decryption key used are different. Therefore, even when different IC cards are used with a mobile terminal whose use is open to a plurality of users, the data stored in the mobile terminal will not be browsed by other users, thus ensuring complete data security.

In addition, the decrypted data is decided as to whether it is correctly decrypted or not. If the decrypted data is decided not to be correct, the decrypted data cannot be displayed or reproduced, and a message to the effect that the decrypted data is incorrect will be notified. Therefore, even when decryption is carried out incorrectly, the data becomes invalid. This enhances data security, and it is also possible to allow a user to confirm a data access with a wrong IC card.

In the above, the description has been made of the preferred embodiment according to the present invention. However, the present invention will not be limited to such embodiment.

More specifically, in FIG. 1, the data encryption processing unit 110 may execute encryption processing in the IC card 3. In this case, a program for encryption processing is stored in the ROM 3b (FIG. 3). When processing is carried out in the data encryption processing unit 100, the data 10 is fed to the IC card 3, and the CPU 3a (FIG. 3) executes the program to encrypt the data 10. The encrypted data is output from the IC card 3 and is stored in the storage device 7. In this case, when the encryption key 4 is stored in the nonvolatile memory 3c (FIG. 3) as being contained in the digital certificate 20 as shown in FIG. 6, the digital certificate 20 is read from the nonvolatile memory 3c, and the encryption key 4 is extracted from the nonvolatile memory 3c before being used for encryption processing of the data 10.

In addition, the data encryption processing unit 100 may execute encryption processing using a key of symmetric encryption algorithm as described for FIG. 9. In this case, the IC card 3 is provided with means for generating a key of symmetric encryption algorithm, although not shown in FIG. 3. For a case where the CPU 3a (FIG. 3) encrypts data 10 (FIG. 1) that is input from the I/O device 3e (FIG. 3), initiation of processing in the data encryption processing unit 100 triggers execution of the program for encryption processing stored in ROM 3b, random numbers are generated in the above-described means for generating a key, and a key of symmetric encryption algorithm is generated and stored in the RAM 3d (FIG. 3). Thereafter, the data 10 which is input by using the key of symmetric encryption algorithm stored in the RAM 3d is encrypted to generate the actual encryption data 32a (FIG. 10). Further, the key of symmetric encryption algorithm is encrypted with the encryption key 4 (FIG. 1) to generate the encryption key data 31d (FIG. 10), and the encryption data 30 shown in FIG. 10 is generated based on such actual encryption data 32a and the encryption key data 31d. Finally, the encryption data 30 is fed to the storage device 7 (FIG. 1) from the I/O device 3e.

Further, in the above-described embodiment, the data 10 from the personal information registration processing unit 8 and the data 10 from the data downloading processing unit 9, or, in other words, all input data 10, are encrypted in the data encryption processing unit 100 or other devices. Alternatively, however, regarding data, among input personal information, which are configured by a user not to be open to other persons, and copyrighted data among downloaded content data, encryption processing may be carried out by the data encryption processing unit 100 or other devices.

Furthermore, the data encryption processing unit 100 may also encrypt only a part of the data 10; for example, only the first 128 bytes of the data 10, portions of the data 10 not to be open to others, or important portions of the data 10 such as the core portion of the data 10 that is mandatory for understanding the whole data.

1. A mobile terminal comprising:
an IC card interface adapted to detachably mount an IC card including an encryption key to encrypt data, a decryption key to decrypt the data encrypted with the encryption key to the original data, and a decryption processing unit;
a data encryption processing unit which captures the encryption key from the IC card mounted and encrypts input data with the encryption key;
a storage device which stores the encrypted data supplied from the data encryption processing unit; and
a data decryption processing unit which decrypts the encrypted data read from the storage device in the decryption processing unit of the IC card by using the decryption key;
wherein a set of encryption key and decryption key, which is assigned to each IC card, is respectively different.

2. A mobile terminal according to claim 1, wherein:
said data encryption processing unit generates random numbers to create a key of a symmetric encryption algorithm; encrypts said data by using the key of symmetric encryption algorithm to make actual encryption data; and encrypts the key of symmetric encryption algorithm with said encryption key to make encryption key data, thus creating encryption data including the encryption key data and actual encryption data; and
the encryption data is stored in said storage device.

3. A mobile terminal comprising:
an IC card interface adapted to detachably mount an IC card including an encryption key to encrypt data, a decryption key to decrypt the data encrypted with the encryption key to the original data, a encryption processing unit and a decryption processing unit;
a data encryption processing unit which encrypts input data in the encryption processing unit by using the encryption key of the IC card;
a storage device which stores the encrypted data supplied from the data encryption processing unit; and
a data decryption processing unit which decrypts the encrypted data read from the storage device in the decryption processing unit of the IC card by using the decryption key;
wherein a set of encryption key and decryption key, which is assigned to each IC card, is respectively different.

4. A mobile terminal according to claim 3, wherein:
said encryption processing unit of said IC card generates random numbers to create a key of a symmetric encryption algorithm; encrypts said data by using the key of symmetric encryption algorithm to make actual encryption data; and encrypts the key of symmetric encryption algorithm with said encryption key to make encryption key data, thus creating encryption data including the encryption key data and actual encryption data; and
the encryption data is stored in said storage device.

5. A mobile terminal according to claim 2, wherein:
said decryption processing unit of said IC card decrypts the encrypted key data of said encryption data read from said storage device by using said decryption key to recover said key of symmetric encryption algorithm, decrypts said actual encryption data of said encryption data by using the key of symmetric encryption key thus recovered, and recover the actual encryption data to the original data.

6. A mobile terminal according to claim 1, wherein said encryption key is contained and stored in a digital certificate and is used for encryption processing as being extracted from the digital certificate.

7. A mobile terminal according to claim 1, wherein only data for which security must be ensured is encrypted.

8. A mobile terminal according to claim 1, wherein said data is encrypted partially.

9. A mobile terminal according to claim 1, further comprising a data protection unit which decides whether the decrypted data has been correctly decrypted or not, displays or reads the decrypted data only when decryption is carried out correctly, and, if the decryption is not correct, notifies a message to the effect that the decryption is incorrect.

10. A data protection system, wherein:
an IC card includes an encryption key to encrypt data and a decryption key to decrypt the data encrypted with the encryption key to the original data;
input data is encrypted by using the encryption key captured from the IC card and stored in a storage device;
the stored encrypted data is decrypted in the IC card by using the decryption key; and
a set of encryption key and decryption key, which is assigned to each IC card, is respectively different.

11. A data protection system, wherein:
an IC card includes an encryption key to encrypt data and a decryption key to decrypt the data encrypted with the encryption key to the original data;
input data is encrypted by using the encryption key in the IC card and stored in a storage device;
the stored encrypted data is decrypted in the IC card by using the decryption key; and
a set of encryption key and decryption key, which is assigned to each IC card, is respectively different.

12. A data protection system according to claim 10,
wherein said encrypted and stored data is encryption data comprising said actual encryption data which is created by encrypting said data with a key of symmetric encryption algorithm generated from random numbers and said encryption key data which is created by encrypting the key of symmetric encryption algorithm with said encryption key.

13. A data protection system according to claim 12,
wherein decryption processing of said encryption data comprising steps of:
decrypting said encryption key data of said encryption data by using said decryption key to recover said key of symmetric encryption algorithm; and
decrypting said actual encryption data of said encryption data by using the recovered key of symmetric encryption algorithm for recovery to the original data.

14. A data protection system according to claim 10,
wherein said encryption key is contained and stored in a digital certificate and is extracted from the digital certificate for use with encryption processing.

15. A data protection system according to claim 10,
wherein said decrypted data is decided as to whether it is correctly recovered or not, and, only if the decrypted data is correctly decrypted, said decrypted data is displayed or read, or if the decrypted data is not recovered correctly, a message to the effect that the decrypted data is incorrect is notified.
